(19) United States
(12) Patent Application Publication
(10) Pub. No.: US 2015/0047015 A1
(43) Pub. Date: Feb. 12, 2015

(54) ACCESS CONTROL FOR HARDWARE UNITS

(71) Applicant: Mika Lahteenmaki, Tampere (FI)

(72) Inventor: Mika Lahteenmaki, Tampere (FI)

(73) Assignee: Nokia Corporation, Espoo (FI)

(21) Appl. No.: 14/375,564

(22) PCT Filed: Feb. 27, 2012
(86) PCT No.: PCT/FI2012/050196

§ 371 Date: Oct. 11, 2014

(51) Int. Cl. G06F 21/62; G06F 21/44

(52) U.S. Cl. CPC G06F 21/62; G06F 21/44
USPC 726/17

(57) ABSTRACT

The invention relates to providing access control to service units of a computer system. When a program unit such as a process or a thread accesses a service unit, the service unit generates an access signal (e.g. an interrupt) indicating the service unit has been accessed. This access signal is handled e.g. by an interrupt handling arrangement at the processor, and in case the program unit is not authorized to access the service unit, the program unit is terminated.

### BACKGROUND

Delivery of applications to computers and mobile devices like smart phones has become easier with the birth of application stores. From these on-line stores, it is possible to purchase and download an application to the device in a simple manner without the requirement complex installation or configuration procedures. At the same time, the capabilities of different devices have increased, and the devices now commonly offer features like a high-resolution camera, fast access to internet services, ability to access e-mail and process documents and so on. New applications make use of these resources of the device.

For various reasons, it may be desirable to limit the application's access to the resources of the device. For example, it may be desirable to disable the application's access to the camera or microphone of the device for privacy reasons. Furthermore, access to communication functionalities may be prevented to avoid excessive communication costs. Generally, data security of devices, e.g. against malicious software like viruses and spyware is a concern.

There is, therefore, a need for solutions for providing access control to the resources of user devices.

### SUMMARY OF THE INVENTION

Now there has been invented an improved method and technical equipment implementing the method, by which the above problems are alleviated. Various aspects of the invention include a method, an apparatus and a computer readable medium comprising a computer program stored therein, which are characterized by what is stated in the independent claims. Various embodiments of the invention are disclosed in the dependent claims.

The invention relates to providing access control to service units of a computer system. When a program unit such as a process or a thread accesses a service unit, the service unit generates an access signal (e.g. an interrupt) indicating the service unit has been accessed. This access signal is handled e.g. by an interrupt handling arrangement at the processor, and in case the program unit is not authorized to access the service unit, the program unit is terminated.

The service unit may be a hardware unit such as a processing unit, a processor block, a communications unit, a data storage unit, a camera, and a microphone. The hardware unit may have a line for generating an interrupt to the processor, that is, a line that is configured to be connectable to an interrupt line of the processor. The interrupt line may be a hardware interrupt line or a software interrupt line. The processor may mask the interrupts when the program unit is authorized to access the hardware unit, and otherwise the interrupt may be processed by an interrupt handler. The interrupt handler may be configured to terminate the accessing process (the program unit) so that when an unmasked interrupt is received, it is deemed that the process has no access rights. In other words, an interrupt signal may be used to indicate access from a process to a hardware unit, and the process may be terminated if the access was unauthorized.

According to a first aspect there is provided a method comprising accessing from a program unit a service unit for service, receiving an access signal related to the service unit in response to the accessing, determining whether the accessing is authorized, and if the accessing is not authorized, terminating the program unit.

According to an embodiment, the service unit is a hardware unit and the access signal is a hardware signal such as a hardware interrupt from the service unit. According to an embodiment, the signal is a software interrupt or a software exception from the service unit. According to an embodiment, the signal comprises information indicative of the program unit. According to an embodiment, the signal is an interrupt and the method comprises setting up an interrupt handler for handling the interrupt, receiving the interrupt, handling the interrupt in the interrupt handler, and terminating the program unit with the interrupt handler. According to an embodiment, the method comprises setting up the interrupt handler in response to the program unit not having rights to access the service unit, and masking the interrupt in response to the program unit having rights to access the service unit. According to an embodiment, the accessing is authorized if the program unit has rights to access the service unit. According to an embodiment, the accessing comprises transferring data with the service unit such as receiving data, storing data or processing data, or the accessing comprises sending one or more control signals to a service unit. According to an embodiment, the program unit comprises at least one from the group of a thread, a process, an application and a user shell. According to an embodiment, the service unit comprises at least one from the group of a processing unit, a processor block, an i/o unit, a data storage unit, a camera, and a microphone. According to an embodiment, the terminating comprises alerting a user of the accessing or of the terminating. According to an embodiment, the method comprises executing the program unit in a pre-emptive environment, wherein the program unit is set for execution in at least a first time period and at a second time period, and during the first and second time period another program unit being set for execution in the pre-emptive environment, accessing from a program unit a service unit for service during the first time period, receiving the access signal during the first time period, and terminating the program unit during the first time period.

According to a second aspect there is provided an apparatus comprising at least one processor, at least one memory including computer program code for one or more program units, the at least one memory and the computer program code configured to, with the processor, cause the apparatus to at least access from a program unit a service unit for service, receive an access signal related to the service unit in response to the accessing, determine whether the accessing is authorized, and if the access is not authorized, terminate the program unit.

According to an embodiment, the apparatus comprises a hardware signal line for receiving the access signal from the service unit, wherein the service unit is a hardware unit and the access signal is a hardware signal such as a hardware interrupt. According to an embodiment, the signal is a software interrupt or a software exception from the service unit, and the apparatus further comprising computer program code configured to, with the at least one processor, cause the apparatus to receive a software interrupt in response to the access. According to an embodiment, the signal comprises information indicative of the program unit. According to an embodiment, the signal is an interrupt and the apparatus further comprises computer program code configured to, with the at least one processor, cause the apparatus to set up an interrupt handler for handling the interrupt, receive the interrupt, handle the interrupt in the interrupt handler, and terminate the program unit with the interrupt handler. According to an embodiment, the apparatus comprises computer program code configured to, with the at least one processor, cause the apparatus to set up said interrupt handler in response to said program unit not having rights to access said service unit, and mask said interrupt in response to said program unit having rights to access said service unit. According to an embodiment, the access is authorized if the program unit has rights to access the service unit, and the apparatus comprises a rights indicator indicating whether a program unit has rights to access a service unit. According to an embodiment, the accessing comprises transferring data with the service unit such as receiving data, storing data or processing data. According to an embodiment, the program unit comprises at least one from the group of a thread, a process, an application and a user shell. According to an embodiment, the apparatus comprises the service unit and the service unit comprises at least one from the group of a processing unit, a processor block, an i/o unit, a data storage unit, a camera, and a microphone. According to an embodiment, the terminating comprises alerting a user of the accessing or of the terminating and the apparatus comprises means for alerting a user of the terminating. According to an embodiment, the apparatus comprises computer program code configured to, with the at least one processor, cause the apparatus to execute the program unit in a pre-emptive environment, wherein the program unit is set for execution in at least a first time period and at a second time period, and during the first and second time period another program unit being set for execution in the pre-emptive environment, access from a program unit a service unit for service during the first time period, receive the access signal during the first time period, and terminate the program unit during the first time period.

According to a third aspect there is provided a module, comprising an access line for providing access to the module, and a signal line for transmitting an access signal in response to the access, wherein the access signal is indicative that the module has been accessed.

According to an embodiment, the signal line is a line for connecting to an interrupt line of a processor, and the access signal is a hardware interrupt signal. According to an embodiment, the signal line is a line for delivering a software interrupt or a software exception, and the module comprises a generator for generating a software interrupt or a software exception in response to the access. According to an embodiment, the signal comprises program unit information indicative of a program unit accessing the module, and the module comprises a former for forming the program unit information for the signal. According to an embodiment, the module comprises at least one from the group of a processing unit, a processor block, an i/o unit, a data storage unit, a camera, and a microphone.

According to a fourth aspect there is provided a computer program product including one or more sequences of one or more instructions which, when executed by one or more processors, cause an apparatus to perform at least the following: access from a program unit a service unit for service, receive an access signal related to the service unit in response to the accessing, determine whether the accessing is authorized, and if the accessing is not authorized, terminate the program unit.

According to an embodiment, the service unit is a hardware unit and the access signal is a hardware signal such as a hardware interrupt from the service unit. According to an embodiment, the signal is a software interrupt or a software exception from the service unit. According to an embodiment, the signal comprises information indicative of the program unit. According to an embodiment, the signal is an interrupt and the computer program product comprises one or more sequences of one or more instructions which, when executed by one or more processors, cause an apparatus to perform at least the following: set up an interrupt handler for handling the interrupt, receive the interrupt, handle the interrupt in the interrupt handler, and terminate the program unit with the interrupt handler. According to an embodiment, the computer program product comprises one or more sequences of one or more instructions which, when executed by one or more processors, cause an apparatus to perform at least the following: set up the interrupt handler in response to the program unit not having rights to access the service unit, and mask the interrupt in response to the program unit having rights to access the service unit. According to an embodiment, the computer program product comprises one or more sequences of one or more instructions which, when executed by one or more processors, cause an apparatus to perform at least the following: execute the program unit in a pre-emptive environment, wherein the program unit is set for execution in at least a first time period and at a second time period, and during the first and second time period another program unit being set for execution in the pre-emptive environment, access from a program unit a service unit for service during the first time period, receive the access signal during the first time period, and terminate the program unit during the first time period.

According to a fifth aspect there is provided a computer program product comprising a computer-readable medium bearing computer program code embodied therein for use with a computer, the computer program code comprising code for accessing from a program unit a service unit for service, code for receiving an access signal for the service unit in response to the accessing, code for determining whether the accessing is authorized, and code for, if the accessing is not authorized, terminating the program unit.

According to an embodiment of a fourth or a fifth aspect, the accessing is authorized if the program unit has rights to access the service unit. According to an embodiment of a fourth or a fifth aspect, the accessing comprises transferring data with the service unit such as receiving data, storing data or processing data. According to an embodiment of a fourth or a fifth aspect, the program unit comprises at least one from the group of a thread, a process, an application and a user shell. According to an embodiment of a fourth or a fifth aspect, the service unit comprises at least one from the group of a processing unit, a processor block, an i/o unit, a data storage unit, a camera, and a microphone. According to an embodiment of a fourth or a fifth aspect, the terminating comprises alerting a user of the accessing or of the terminating. According to an embodiment of a fourth or a fifth aspect, the computer program product comprises an operating system embodied on a computer-readable medium.

According to a sixth aspect there is provided a system comprising at least one instance of at least one from the group of an apparatus according to the second aspect, a module according to the third aspect and a computer program product according to the third or fourth aspect.

According to a seventh aspect there is provided use of a hardware interrupt for indicating to a processor an accessing of a service unit from the processor.

According to an eighth aspect there is provided an apparatus, comprising means for accessing from a program unit a service unit for service, means for receiving an access signal related to the service unit in response to the accessing, means for determining whether the accessing is authorized, and means for terminating the program unit if the accessing is not authorized.

According to an embodiment, the service unit is a hardware unit and the access signal is a hardware signal such as a hardware interrupt from the service unit. According to an embodiment, the signal is a software interrupt or a software exception from the service unit. According to an embodiment, the signal comprises information indicative of the program unit. According to an embodiment, the signal is an interrupt and the apparatus comprises means for setting up an interrupt handler for handling the interrupt, means for receiving the interrupt, means for handling the interrupt in the interrupt handler, and means for terminating the program unit with the interrupt handler. According to an embodiment, the apparatus comprises means for setting up the interrupt handler in response to the program unit not having rights to access the service unit, and means for masking the interrupt in response to the program unit having rights to access the service unit. According to an embodiment, the accessing is authorized if the program unit has rights to access the service unit. According to an embodiment, the means for accessing comprises means for transferring data with the service unit such as receiving data, storing data, processing data or sending one or more control signals to the service unit. According to an embodiment, the program unit comprises at least one from the group of a thread, a process, an application and a user shell. According to an embodiment, the service unit comprises at least one from the group of a processing unit, a processor block, an i/o unit, a data storage unit, a camera, and a microphone. According to an embodiment, the means for terminating comprises means for alerting a user of the accessing or of the terminating. According to an embodiment, the apparatus comprises means for executing the program unit in a pre-emptive environment, wherein the program unit is set for execution in at least a first time period and at a second time period, and during the first and second time period another program unit being set for execution in the pre-emptive environment, means for accessing from a program unit a service unit for service during the first time period, means for receiving the access signal during the first time period, and means for terminating the program unit during the first time period.

### DESCRIPTION OF THE DRAWINGS

In the following, various embodiments of the invention will be described in more detail with reference to the appended drawings, in which

FIG. 1 shows a flow chart of a method for providing access control according to an embodiment;

FIG. 2 shows an apparatus for providing access control according to an embodiment;

FIG. 3 shows a module with access control according to an embodiment;

FIG. 4 shows a computer program product for providing access control according to an embodiment;

FIG. 5 shows a signaling diagram for providing access control according to an embodiment; and

FIG. 6 shows a flow chart of a method for providing access control according to an embodiment.

### DETAILED DESCRIPTION OF THE EMBODIMENTS

In the following, several embodiments of the invention will be described in the context of various service units of a computer system. It is to be noted, however, that the invention is not limited to such implementations. In fact, the different embodiments have applications in any environment where access control and security is required.

In a computer system, executable programs and data are loaded into memory, where they can be accessed by the processor (or multiple processors). The processor is able to carry out program commands that the executable program comprises. Commands are moved from the memory into the execution registers (or into an execution pipeline) and executed. In the course of execution, the processor may access data or other services like computation or communication from other units of the computer. For example, data may be written onto a hard disk or a picture may be taken with a camera. An operating system (a software program of sorts) takes care of managing different hardware, managing the execution of programs by the processor and typically providing a user interface through which a human can interact with the computer.

When a program unit (a program, a thread, a process, or any piece of code executed on the processor) accesses a hardware unit (a service unit), the hardware unit typically needs the processor to communicate with it. For this purpose, it is common that the hardware unit issues an interrupt to which the processor responds by executing an interrupt routine so that the hardware unit can be taken care of. A similar arrangement may be used on the software level: a software unit may send a message to the operating system, and the operating system will arrange that the processor is used to respond to the software unit. Program units running on the system may have different access rights for accessing hardware and software units. For example, some program units may be banned from writing to the hard disk or using the camera.

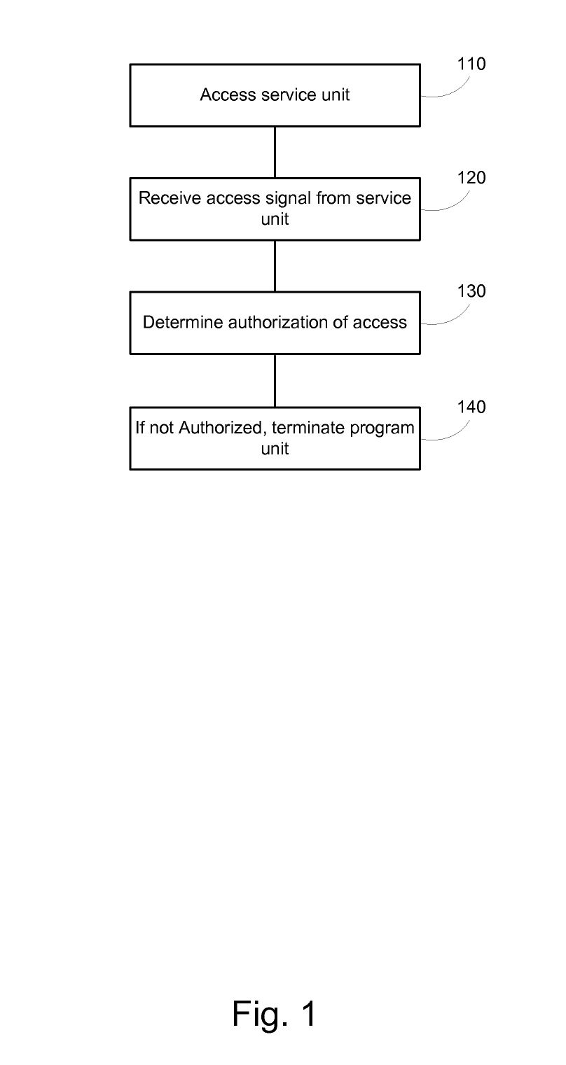

FIG. 1 shows a flow chart of a method for providing access control according to an embodiment. In phase 110, a program unit accesses a service unit for service. For example, a thread or a process running on at least one processing unit may access a camera, a communication module, a mass memory like a hard disk or the microphone for data. At this phase, the needed device driver may be activated, and thus data may be sent to the service unit, e.g. by writing one of its registers. The operating system, more precisely the process scheduler of the operating system, may mark the program unit as waiting for i/o (input/output) so that the program unit continues execution when the service unit returns with data. The information about which service unit was accessed may be stored.

In phase 120, the service unit detects that it has been accessed for service and issues an access signal to the processor (or one of the processors). This access signal may be a message (a software signal or an exception) or it may be a state change on a hardware line such as a hardware interrupt line, or a change in the contents of a hardware register/memory. The processor may switch control from the program unit to a routine for handling the access signal, e.g. an interrupt routing.

In phase 130, the authorization of the program unit to access the service unit is determined. For example, the program unit may have a certain level of access rights or certain listed rights in its possession. These access rights may be used e.g. by the operating system to control the access of this program unit to service units. This may happen in various ways, for example through determining what kind of action, if any, to take when a program unit accesses a service unit. For example, the operating system may set the interrupt vector table up so that the table contains interrupt vectors (pointers to interrupt handlers) that are specific to the current program unit being executed on the processor. Each program unit may have its own set of interrupt vectors, or the units may have common interrupt vectors. Some or all of the interrupts may be masked so that the interrupt handlers are not called, e.g. so that interrupts coming from service units that the program unit is authorized to access are masked.

In phase 140, the program unit that accessed the service unit may be terminated if it was determined that the program unit has no access rights to access the service unit, or that the access rights are insufficient. That is, if the program unit was not authorized to access the service unit, the processor/operating system may kill the program unit. This may happen e.g. so that an interrupt handler contains code that will cause the processor and the operating system to terminate the program unit (kill it), put it on hold by marking it not allowed for execution, or reduce its priority.

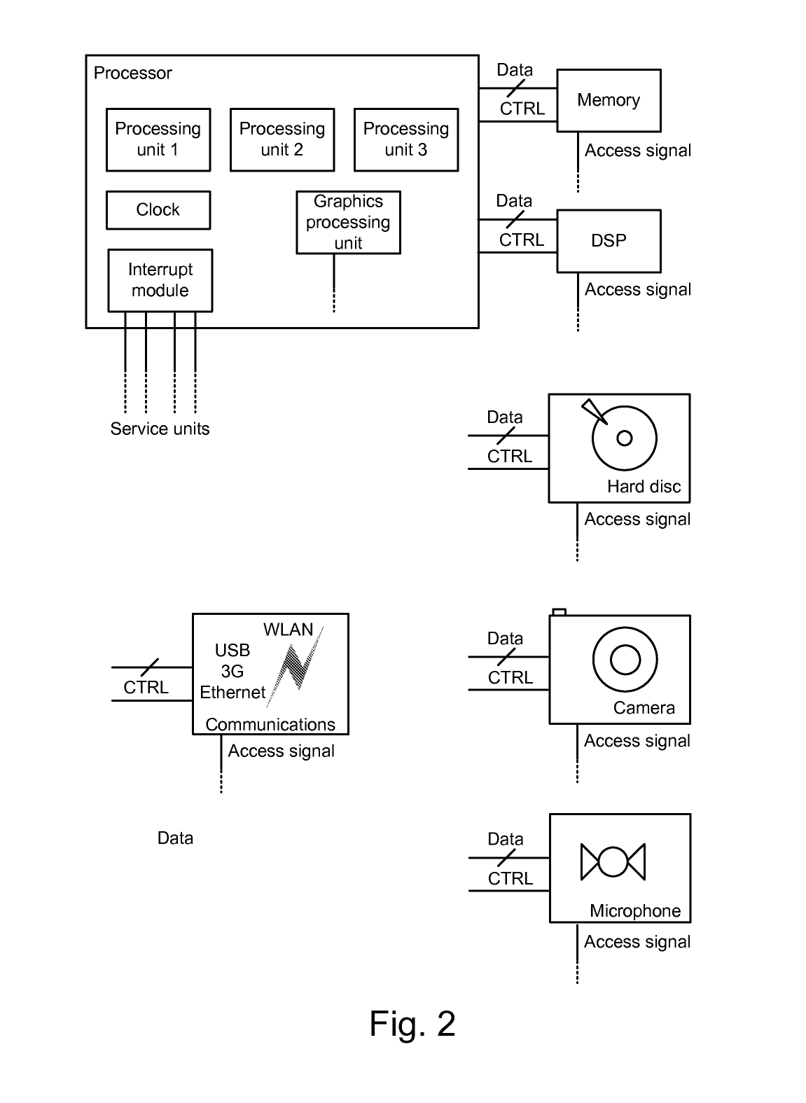

FIG. 2 shows an apparatus or a system for providing access control according to an embodiment. The Processor (e.g. an integrated circuit) may comprise a plurality of processing units such as general purpose Processing units 1, 2 and 3, and a Graphics processing unit; a Clock (either internal or external); and an Interrupt module (either internal or external). The processing units are able to run executable program code, that is, execute instructions. The Clock provides a clock signal e.g. for the purpose of stepping through instructions at the processing units, and for the purpose of scheduling different program units for execution on the processing units by counting time. The Clock may generate a clock interrupt at the interrupt module.

The interrupt module may take care of prioritization of different interrupts. For example, interrupts having a smaller interrupt number may have a higher priority than the ones with a larger interrupt number. The interrupt handler may indicate to the processing unit, or one of the processing units, that an interrupt has been issued and needs handling. The processing unit may then switch to processing the interrupt handler. This may happen so that the current process context is stored and a new one (the interrupt handler's context) is switched in place.

The processor may also have various control lines CTRL and/or various data lines or data buses Data for communicating with service units. Such control, data and interrupt lines may exist also internally in the processor for communicating between different units of the processor, e.g. the Graphics processing unit and the Processing unit 1.

The apparatus or system of FIG. 2 may comprise different service units like Memory, digital signal processor DSP, Hard disk, Camera, Microphone and Communications units, or internal service units like Processing unit 2 or Graphics processing unit. These service units may each have one or more control lines and data lines/data buses for communicating with the service units. The different service units contain functionality for providing the service, e.g. the memory has memory locations for storing data, the DSP has a digital signal processor, the camera has optics and image capture means, and so on. A service unit may provide one or more services, e.g. the Communications unit may provide the services of one or more communication means like 3G, WLAN, Ethernet or USB communications.

Each of the service units may be arranged to be able to send an Access signal when the service unit is accessed. This Access signal may be connected to the Interrupt handler of the Processor. That is, the hardware units may generate an interrupt when they are accessed (possibly in addition to the interrupt they generate when they request for service from the processor). Thus, there is a low-level signal available to the processor when a service unit has been accessed. There may be more than one Access signal from a service unit. For example, a first Access signal may be sent when the service unit receives a control signal, e.g. to enable the service unit. A second Access signal may be sent when the service unit is accessed so that data is requested. A third Access signal may be sent when the service unit is accessed so that data is written into the service unit. This low-level Access signal is handled by the operating system and the processor in a state and at a level where program units do not have access. Consequently, it may be more difficult for a malicious program unit to gain unauthorized access to a service unit (e.g. camera or microphone) without being detected. When an unauthorized access is detected, the program unit may be terminated, as explained earlier.

It needs to be appreciated that there may be various ways in which the access signal may be transmitted from the service unit. A hardware interrupt, a software interrupt (along control/data lines), a message in the communication protocol between the processor and the service unit or any other means may be used for indicating that the service unit has been accessed. The access signal may contain an indication of the program unit that accessed the service unit. That is, the program unit may send its identity to the service unit, and the service unit may include this identity information (e.g. a process number/identification) in the access signal. The access signal may be sent essentially without delay, e.g. before any data is sent to the processor. The service unit may also wait for an acknowledgement from the processor that the access was authorized before sending data. The access signal may be sent along a single hardware line or a pair of hardware lines, or a shielded pair of hardware lines, e.g. as a serial signal, thereby enabling identification of which process or unit accessed the service unit.

As explained earlier, interrupt handler routines may be used to handle the interrupts. This may be achieved by setting up pointers (interrupt vectors) to programs that are to be executed when an interrupt is received.

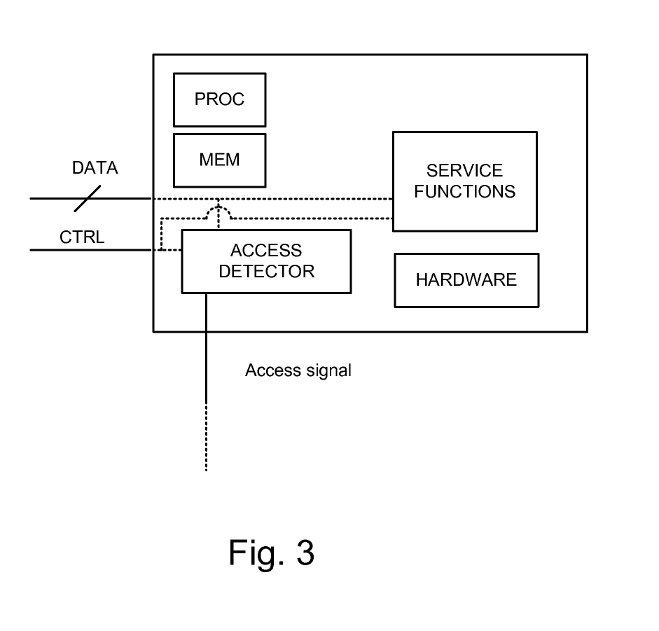

FIG. 3 shows a module with access control according to an embodiment. A module may comprise an access line (e.g. control and/or data lines/buses DATA and CTRL) for providing access to the module, and an access signal line for transmitting an Access signal in response to the access, so that the access signal indicates that the module has been accessed. The module may comprise one or more processors PROC and one or more memory units MEM. There may be circuitry and/or program(s) to provide the service functions of the module. The module may comprise specialized hardware HARDWARE used in providing the service, e.g. optics.

The module may comprise an access detector ACCESS DETECTOR for detecting that the module has been accessed. The access detector may be a software or a hardware unit or a mix of these. The access detector may be connected to the data and control lines, and the service functions and hardware of the module. By sensing the signals in these parts, the access detector may detect that the module has been accessed, and generate an access signal.

The access signal line may be a line for connecting to an interrupt line of a processor, and the access signal may be a hardware interrupt signal. The access signal line may be a line or bus for delivering a software interrupt or a software exception, and the module may comprise a generator for generating a software interrupt or a software exception in response to the access. If the module has received information of the program unit that accessed the module, the access signal may comprise program unit information indicative of the program unit accessing the module, and the module may thus comprise a former for forming the program unit information for the access signal in appropriate format. As explained earlier, the module may comprise at least one from the group of a processing unit, a processor block, an i/o unit, a data storage unit, a camera, and a microphone.

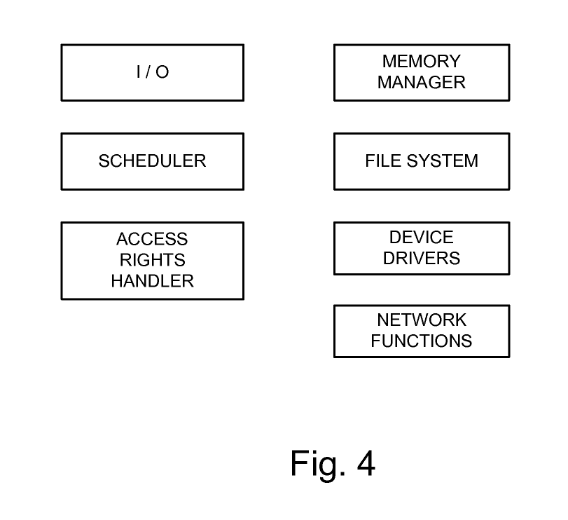

FIG. 4 shows a computer program product for providing access control according to an embodiment. The computer program product may be stored on a non-transitory computer-readable medium such as a DVD disk, a computer in the computer memory, a hard drive unit, or an internet server, or on a transitory computer-readable medium such as a signal en route to the receiver e.g. over the air or over a fixed network connection. The computer program product may be e.g. an operating system, or an operating system kernel, or program code or libraries for building and linking such.

The computer program product like and operating system may contain the following parts. An i/o module may provide for the input/output functionalities such as user interface functions. The memory manager may handle the allocation of memory to the program units. The scheduler may manage the allocation of processor time to the program units. This may happen in a pre-emptive manner so that multiple program units may be executed virtually simultaneously. The file system manager may handle different formats of file systems, access and writing to the file systems as well as rights to access various files. The device drivers may be used to provide high-level access and communication to service units of the system. For example, a camera device driver may offer an interface through which it is easy to request for an image without needing to bother with the details of reading data from the imaging hardware. The network functions may provide communication functionality e.g. by providing an internet connection through an Ethernet or WLAN carrier.

There may also be an access rights handler that takes care of managing the access rights of different program units and taking care that the program units do not act beyond their rights. The program product or operating system may manage the execution of various program units such as processes, threads, applications and user shells. If a program unit operates beyond its rights, the operating system may take care of terminating the program unit e.g. by killing, halting or removing priority from the program unit. The system may also prompt the user than an unauthorized access has taken place. This terminating may happen through the use of an interrupt handler as presented earlier, or a signal handler in the operating system/program product.

The operating system may run the program units in a pre-emptive manner. That is, the execution of different program units may be alternated so that each program unit gets its turn to occupy the processor (or a processing unit of a processor). This may be handled so that a scheduler of the operating system manages the allocation of processing time slices to the different program units, and when it comes time to change the program unit, the dispatcher of the operating system stores the current context, loads a new context and jumps to execute the new program unit. Some of the operations in a pre-emptive system may be such that they cannot be interrupted or switched away from, e.g. kernel operations or operations affecting shared data. Interrupts may thus be prevented during the time when such a non-interruptible operation is executing. For example, if a process accesses a hardware device, interrupts may be prevented during such operation so that the access process can complete essential operations. Additionally or instead, the sending of an access signal from a service unit may be arranged to be fast so that the access signal is received during the same time slice (execution of the same process). Additionally or instead, the access signal may contain information of the accessing program unit so that the system may identify the program unit that accessed the service unit even if the execution has been switched to the next program unit.

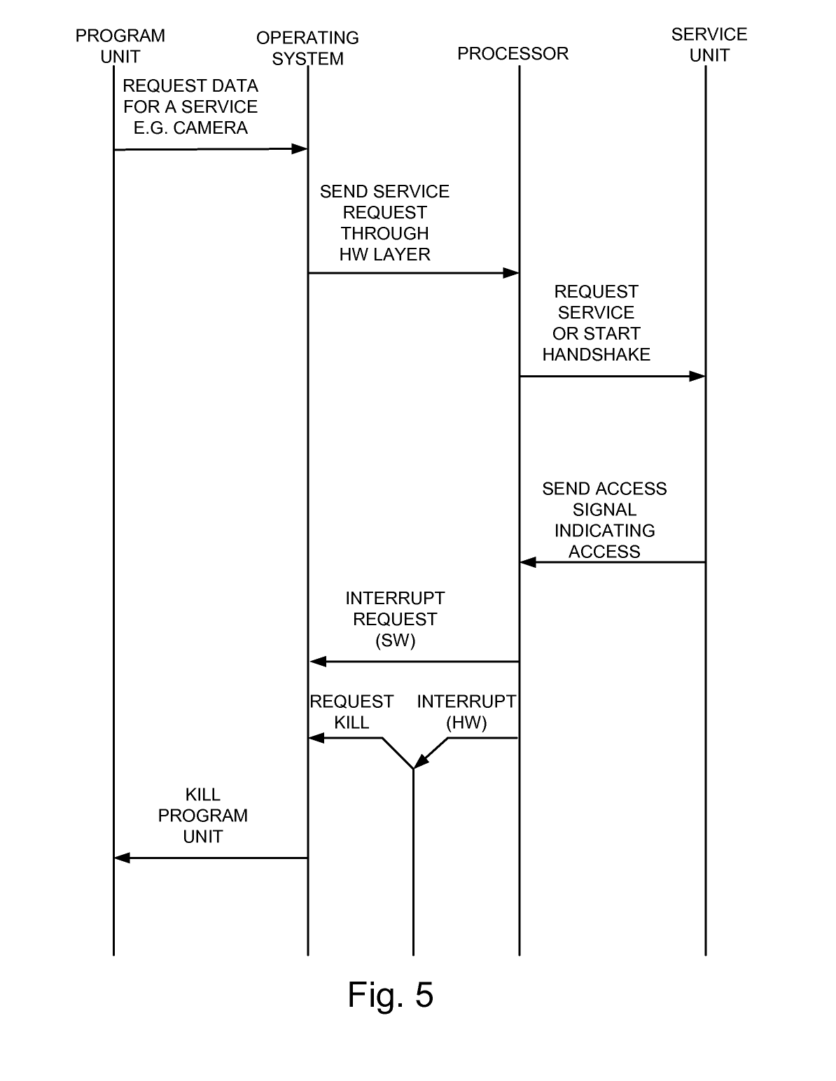

FIG. 5 shows a signaling diagram for providing access control according to an embodiment. There are four entities communicating with each other here: the program unit, the operating system on which the program unit is running, the processor executing the operating system and the program unit, and the service unit that provides a service to the program unit.

First, the program unit sends a request for data or for other service such as processing from the service unit by making a call to the operating system (e.g. a device driver of the operating system). The operating system runs the necessary code e.g. of the driver to cause the processor to communicate the request to the service unit on hardware level. There may be a layered communication protocol in use in the communication. When the service unit receives the service request from the processor, it sends an access signal to the processor indicating that the service unit has been accessed. As discussed, this can be an interrupt request. A software interrupt causes the operating system to run a handler routine to take care of the interrupt (or signal /exception). A hardware interrupt invokes an interrupt handler through an interrupt vector. Either of these handlers may contain instructions to kill the program unit, to halt it or to remove priority from the unit.

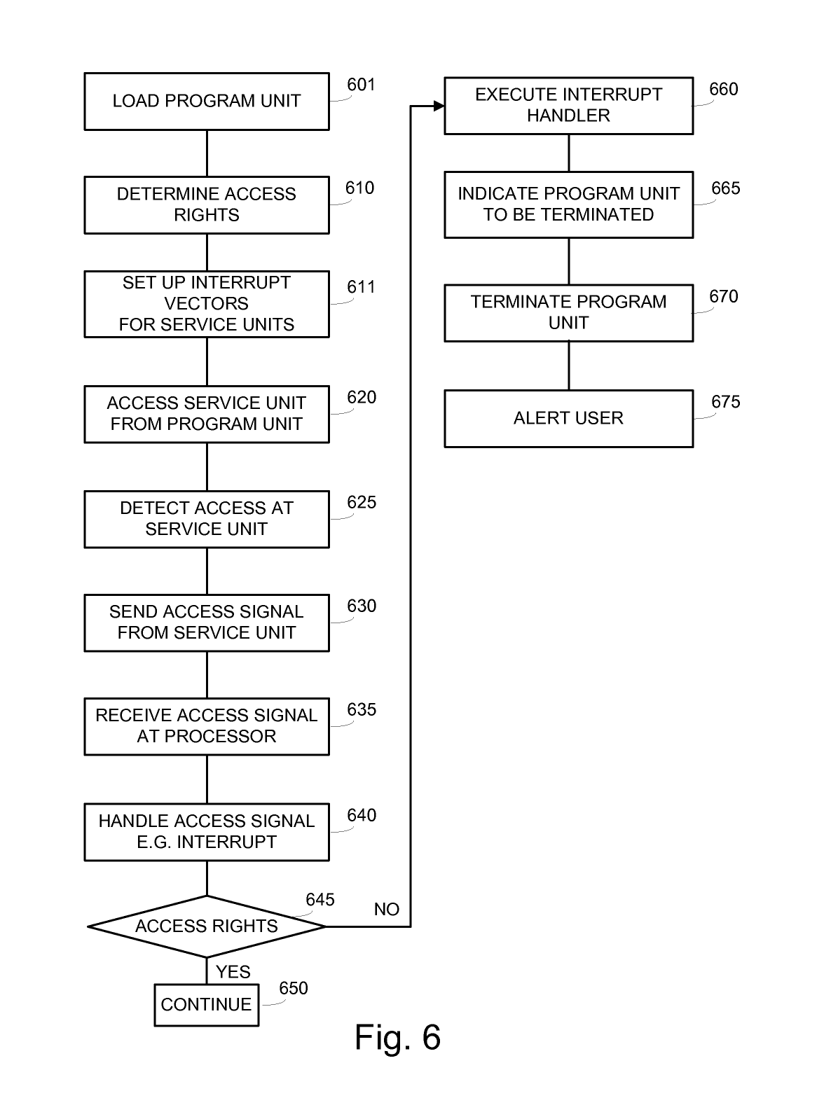

FIG. 6 shows a flow chart of a method for providing access control according to an embodiment. In phase 605, the program unit is loaded in memory for execution. In phase 610, the access rights of the program unit may be determined, e.g. from authorization information and other credentials like signatures and/or certificates of the program unit. In phase 615, interrupt vectors may be set up for interrupts coming from different service units. This may happen according to the access rights of the program unit.

In phase 620, a program unit accesses a service unit for service. For example, a thread or a process running on at least one processing unit may access a camera, a communication module, a mass memory like a hard disk or the microphone for data. At this phase, the needed device driver may be activated, and thus data may be sent to the service unit, e.g. by writing one of its registers. The operating system, more precisely the process scheduler of the operating system, may mark the program unit as waiting for i/o (input/output) so that the program unit continues execution when the service unit returns with data. The information about which service unit was accessed may be stored.

In phase 625, the service unit detects that it has been accessed for service and issues an access signal to the processor (or one of the processors). This access signal may be a message (a software signal or an exception) or it may be a state change on a hardware line such as a hardware interrupt line, or a change in the contents of a hardware register/memory.

In phase 630, the service unit may send an access signal in response to detecting that the service unit has been accessed. This has been explained in the context of FIG. 3.

In phase 635, the access signal is received at the processor and the access signal is handled e.g. through interrupt processing in phase 640. The authorization of the program unit to access the service unit may be determined. For example, the program unit may have a certain level of access rights or certain listed rights in its possession. These access rights may be used e.g. by the operating system to control the access of this program unit to service units. This may happen in various ways, for example through determining in phase 645 what kind of action, if any, to take when a program unit accesses a service unit. For example, the operating system may set up or modify the interrupt vector table so that the table contains interrupt vectors (pointers to interrupt handlers) that are specific to the current program unit being executed on the processor. Each program unit may have its own set of interrupt vectors, or the units may have common interrupt vectors. Some or all of the interrupts may be masked so that the interrupt handlers are not called, e.g. so that interrupts coming from service units that the program unit is authorized to access are masked.

If it is determined in phase 645 that the program unit has access rights to access the service unit, the operation of the program unit, that is the execution of the program unit on the operating system, will continue normally in phase 650.

In phase 670, the program unit that accessed the service unit may be terminated if it was determined in phase 645 that the program unit has no access rights to access the service unit, or that the access rights are insufficient. That is, if the program unit was not authorized to access the service unit, the processor/operating system may kill the program unit. This may happen e.g. so that an interrupt handler is executed in phase 660, and the handler contains code that will cause the processor and the operating system to terminate the program unit (kill it), put it on hold by marking it not allowed for execution, or reduce its priority. Before doing this, the identity of the program unit to be terminated may be determined in phase 665 by e.g. from process number communicated in the interrupt, or by checking from the operating system which process has accessed the service unit in question.

In phase 675, the user may be alerted that an unauthorized access has taken place, and/or the program unit has been terminated.

The various embodiments of the invention can be implemented with the help of computer program code that resides in a memory and causes the relevant apparatuses to carry out the invention. For example, an apparatus may comprise circuitry and electronics for processing, receiving and transmitting data, computer program code in a memory, and a processor that, when running the computer program code, causes the apparatus to carry out the features of an embodiment. Yet further, a module may comprise circuitry and electronics for processing, receiving and transmitting data, computer program code in a memory, and a processor that, when running the computer program code, causes the module to carry out the features of an embodiment. The various embodiments may be implemented as a computer program product that is suitable for running on the apparatus or the module. The computer program product may be embodied on a computer-readable medium such as a non-transitory permanent storage medium, a memory, or as a signal.

It is obvious that the present invention is not limited solely to the above-presented embodiments, but it can be modified within the scope of the appended claims.

1-57. (canceled)

58. A method, comprising:
accessing from a program unit a service unit for service,
receiving an access signal related to said service unit in response to said accessing,
determining whether said accessing is authorized, and
if said accessing is not authorized, terminating said program unit.

59. A method according to claim 58, wherein said service unit is a hardware unit and said access signal is a hardware signal such as a hardware interrupt from said service unit.

60. A method according to claim 58, wherein said signal is a software interrupt or a software exception from said service unit.

61. A method according to claim 58, wherein said signal comprises information indicative of said program unit.

62. A method according to claim 58, wherein said signal is an interrupt and said method comprises:
setting up an interrupt handler for handling said interrupt,
receiving said interrupt,
handling said interrupt in said interrupt handler, and
terminating said program unit with said interrupt handler.

63. A method according to claim 62, comprising:
setting up said interrupt handler in response to said program unit not having rights to access said service unit, and
masking said interrupt in response to said program unit having rights to access said service unit.

64. A method according to claim 58, wherein said accessing is authorized if said program unit has rights to access said service unit.

65. An apparatus comprising at least one processor, at least one memory including computer program code for one or more program units, the at least one memory and the computer program code configured to, with the processor, cause the apparatus to perform at least the following:
access from a program unit a service unit for service,
receive an access signal related to said service unit in response to said accessing,
determine whether said accessing is authorized, and
if said access is not authorized, terminate said program unit.

66. An apparatus according to claim 65, further comprising a hardware signal line for receiving said access signal from said service unit, wherein said service unit is a hardware unit and said access signal is a hardware signal such as a hardware interrupt.

67. An apparatus according to claim 65, wherein said signal is a software interrupt or a software exception from said service unit, and said apparatus further comprising computer program code configured to, with the at least one processor, cause the apparatus to perform at least the following:
receive a software interrupt in response to said access.

68. An apparatus according to claim 65, wherein said signal comprises information indicative of said program unit.

69. An apparatus according to claim 65, wherein said signal is an interrupt and said apparatus further comprises computer program code configured to, with the at least one processor, cause the apparatus to perform at least the following:
set up an interrupt handler for handling said interrupt,
receive said interrupt,
handle said interrupt in said interrupt handler, and
terminate said program unit with said interrupt handler.

70. An apparatus according to claim 65, further comprising computer program code configured to, with the at least one processor, cause the apparatus to perform at least the following:
set up said interrupt handler in response to said program unit not having rights to access said service unit, and
mask said interrupt in response to said program unit having rights to access said service unit.

71. An apparatus according to claim 65, wherein said access is authorized if said program unit has rights to access said service unit, and said apparatus comprises a rights indicator indicating whether a program unit has rights to access a service unit.

72. An apparatus according to claim 65, wherein said accessing comprises transferring data with said service unit such as receiving data, storing data, processing data or sending one or more control signals to said service unit.

73. An apparatus according to claim 65, wherein said program unit comprises at least one from the group of a thread, a process, an application and a user shell.

74. An apparatus according to claim 65, wherein said apparatus comprises said service unit and said service unit comprises at least one from the group of a processing unit, a processor block, an i/o unit, a data storage unit, a camera, and a microphone.

75. An apparatus according to claim 65, wherein said terminating comprises alerting a user of said accessing or of said terminating and said apparatus comprises a user interface and computer program code configured to, with the at least one processor, cause the apparatus to alert a user of said terminating.

76. An apparatus according to claim 65, further comprising computer program code configured to, with the at least one processor, cause the apparatus to perform at least the following:
execute said program unit in a pre-emptive environment, wherein said program unit is set for execution in at least a first time period and at a second time period, and during said first and second time period another program unit being set for execution in said pre-emptive environment,
access from a program unit a service unit for service during said first time period,
receive said access signal during said first time period, and
terminate said program unit during said first time period.

77. A module, comprising:
an access line for providing access to said module, and
a signal line for transmitting an access signal in response to said access, wherein said access signal is indicative that said module has been accessed.
